(19) United States
(12) Patent Application Publication
(10) Pub. No.: US 2006/0188757 A1
(43) Pub. Date: Aug. 24, 2006

(54) Simulated decorative surface

(76) Inventor: Tryggvi Magnusson, Wausau, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/356,530

(22) Filed: Feb. 17, 2006

Related U.S. Application Data
(60) Provisional application No. 60/654,313, filed on Feb. 18, 2005.

(51) Int. Cl. B05D 5/00; B29C 59/00

(52) U.S. Cl. 428/913.3; 427/355; 427/402; 264/293

(57) ABSTRACT

The present invention is a simulated decorative surface formed of a number of components, such as a board, which include a printed pattern and corresponding texture to enable the board to appear similar to boards or other decorative surfaces formed of varying materials. The surface component is formed with a substrate on which is applied a number of printing ink layers to give the surface components a desired pattern or appearance. A number of top coat layers are applied over the printing ink layers in a manner which corresponds to the pattern provided by the printing ink layers such that the top coat layers form a textural pattern on the surface component over the printing layers corresponding to the type of material represented by the printing layers on the surface component. The substrate may also be scraped prior to applying any printing or top coat layers to the decorative surface component in order to provide a textured substrate over which the printing and top coat layers can be applied.

### CROSS-REFERENCE TO RELATED APPLICATIONS

This application claims the benefit of U.S. Provisional patent application Ser. No. 60/654,313, filed on Feb. 18, 2005, the entirety of which is incorporated herein by reference.

### FIELD OF THE INVENTION

The present invention relates to decorative surfaces, and more specifically to decorative surfaces such as furniture and wall panels, flooring boards having both a desired simulated appearance and texture.

### BACKGROUND OF THE INVENTION

Various types of decorative surfaces have been manufactured for use in a variety of different situations in order to provide a more aesthetically pleasing appearance to various surfaces, such as furniture and wall panels, and flooring surfaces in the interior of a building. These decorative surfaces are formed of different materials in order to provide a number of different options with regard to the appearance and/or texture provided by the decorative surface. Thus, to provide a specific appearance and texture for a decorative surface, the surface must be constructed of the specific material having the desired appearance and texture.

However, on many occasions, the type of material required to provide the desired appearance does not fit the particular situation or environment within which the decorative surface is to be utilized due to the properties of the materials used in forming the surface. Additionally, depending upon the particular material selected to provide the desired appearance, the cost of that material can be prohibitively expensive, necessitating that the decorative surface have a different appearance and texture than what is usually desired.

As a result, it is desirable to develop a decorative surface that can be constructed to provide a number of different appearances and/or texture to simulate a decorative surface formed with different materials.

### SUMMARY OF THE INVENTION

According to a primary aspect of the present invention, a decorative surface is provided in which the components of the decorative surface, e.g., the exposed furniture panels, wall panels or the flooring boards, are formed in a manner which enables the surfaces to simulate any of a number of desired appearances and/or textures on the surfaces. More specifically, the substrate of the surface is initially prepared and primed such that the substrate can be printed on in order to provide the board with the desired appearance for the simulated decorative surface. Subsequently, the board is sealed and coated in a manner that provides the individual board and the decorative surface formed with the substrate with a texture corresponding to the desired, simulated appearance for the decorative surface. By creating the substrate in this manner, the substrate can be utilized in assembling a decorative surface having the appearance and texture simulative of a variety of different materials, without the expense and other considerations required when utilizing the actual materials to form the decorative surface.

According to another aspect of the present invention, the decorative surface and substrate utilized in forming the surface can be constructed utilizing readily available materials, such that the manufacturing of these simulative components or substrate can be accomplished utilizing existing technologies.

Numerous other aspects, features and advantages of the present invention will be made apparent from the following detailed description taken together with the drawing figures.

### BRIEF DESCRIPTION OF THE DRAWINGS

The drawings illustrate the best mode currently contemplated in practicing the present invention.

In the drawings:

FIG. 1 is a cross-sectional view of a decorative surface component constructed according to the present invention;

FIG. 2 is a schematic view of the process of forming the decorative surface component of FIG. 1; and

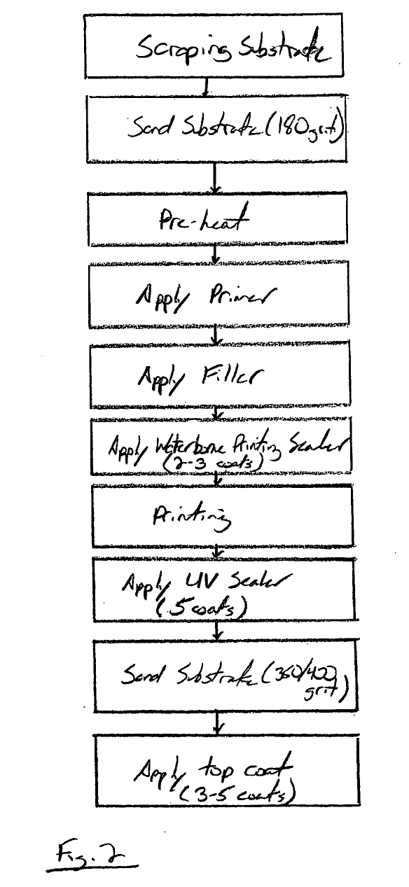

FIG. 3 is a cross-sectional view of a second embodiment of a decorative surface component constructed according to the present invention.

### DETAILED DESCRIPTION OF THE INVENTION

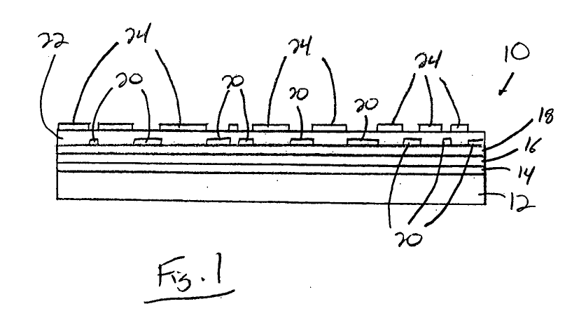

With reference now to the drawing figures in which like reference numerals designate like parts throughout the disclosure, a printed and textured surface component is constructed in accordance with the present invention as illustrated generally at 10 in FIG. 1. Surface component 10 includes substrate 12 formed of any suitable, and preferably inexpensive material, such as a high density fiber board, low density fiber board, plywood or particle board, among others, that is shaped as desired to form the decorative surface (not shown). For example, a substrate 12 can be shaped to have an elongate, rectangular shape similar to that of the conventional hardwood flooring board, but can also be shaped to have a generally square, tile-like configuration or any other desired shape for use in forming the decorative surface depending upon what type of surface the components are to be used to form. The substrate 12 is preferably sanded with 180 grit paper and preheated before use in the method, and can include or later be assembled with any desired securing means (not shown), such as a tongue and groove construction or mechanical or adhesive fastener, in order to attach adjacent surface component 10 to one another when forming the decorative surface.

When manufacturing the surface component 10, the substrate 12 is initially coated with and supports a layer of a primer 14 applied to the substrate 12 which can be any suitable primer for use in manufacturing flooring boards to enable subsequent coating layers to more easily adhere to the substrate 12. A preferred primer 14 is a suitable water-based primer sold by Trustor Coatings, of Wausau, Wis. . The primer 14 provides sufficient adhesion to hold a layer of a suitable filler 16, such as a suitable water-based, solvent-based or radiation curable filler, on the substrate 12. The filler 16 serves to fills in the holes, pores and other uneven surfaces in the substrate 12, and can be applied over the primer 14 in any suitable manner. Further, the filler layer 16 is sanded to smooth the surface formed by the filer layer 16. However, based on the form or material used as the substrate 12, the filler 16, and possibly the primer 14 can be omitted if the substrate 12 is sufficiently smooth and able to adhere to the sealer layers 18 on its own.

Over the filler layer 16 are applied one (1) to three (3) coats of a suitable, and optionally pigmented printing sealer 18. A preferred sealer 18 is a water-based, solvent-based or radiation curable sealer, such as those sold by Trustor Coatings of Wausau, Wis. or Oscar-Nolte of Treibacher, Germany, though any suitable sealer can be used. Again, the sealer layer 18 can be applied to the substrate 12 over the filler layer 16 in any suitable manner.

After the sealer layers 18 have been applied, a number of printing layers 20 can be applied to the sealer layers 18. The printing layers 20 are formed by applying suitable printing inks, such as any suitable water-based, solvent based, or radiation curable inks, including those, sold by Oscar-Nolte of Treibacher, Germany, to the surface of the sealer layers 18 through the use of from one to four printing cylinders (not shown) which are etched or otherwise suitably formed with a pattern illustrating the desired appearance for the flooring boards, such as wood, stone, marble, tile, or the like. The printing ink forming the layers 20 is transferred from a reservoir (not shown) of the ink to the etched cylinder(s) which in turn transfers the ink to a rubber roller (not shown). The rubber roller subsequently contacts the surface component 10 to apply the ink from the roller to the surface component 10 in the desired pattern. Further, the color or combination of colors of the inks used to form the printing layers 20 can be changed as necessary to provide the desired, simulated appearance of surface components 10 used to form the decorative surface. In this manner, multiple printing layers 20 can be formed on the substrate 12 from the same or different colored inks to enhance this simulated appearance.

After the printing layers 20 have been applied, a number of sealer layers 22, preferably two (2) to five (5) in number, are applied over the printing layers 20 in any suitable manner to encapsulate the printing layers 20 within the sealer layers 22. The sealer layers 22 are preferably ultra-violet (UV) curable, and formed of polyurethane, optionally including ceramic powders and other particulates, such as radiation curable sealers, including Alodur ZWSK sold by Oscar-Nolte of Treibacher, Germany, though any suitable sealer can be utilized for the sealer layers 22. The sealer layers 22 are each cured on the substrate 12 by passing the substrate 12 including the sealer layers 22 beneath a radiation source (e.g., a UV light), and the sealer layers 22 are subsequently sanded, preferably with 360/400 grit sandpaper.

After the sealer layers 22 on the surface component 10 have been sanded, a number of top coat layers 24, preferably one (1) to five (5) layers and formed of a suitable top coat, such as a water-based, solvent-based or radiation curable top coat, sold by Trustor Coatings of Wausau, Wis., or Oscar-Nolte of Treibacher, Germany. The top coat layers 24 are applied to the surface component 10 over the cured and sanded sealer layers 22 in a manner which gives the surface component 10 the desired texture or feel corresponding to the simulated appearance for the surface component 10 provided by the printing layers 20. Specifically, the first top coat layer 24 is applied over the entire surface of the sealer layers 22. However, the subsequent top coat layers 24 are applied over the cured and sanded sealer layers 22 by a number of printing cylinders (not shown) and rubber rollers (not shown) in a manner similar to that utilized in applying the printing layers 20 to the surface component 10. However, the cylinders utilized in applying the top coat layers 24 are etched with a pattern thereon which is a virtual negative of the pattern for the cylinders used to apply the printing layers 20. Thus, the top coat layers 24 are applied using the cylinders and rollers in a manner which places the top coat 24 between the lines or other pattern formed by the printing layers 20 already on the surface component 10, such that the top coat layers 24 are essentially printed on the surface component 10. As a result, the areas located between the top coat layers 24 provide a texture or feel to the upper surface of the surface component 10 in conjunction with the top coat layers 24 that is similar to that expected of a decorative surface formed of the material which the surface component 10 is formed to be simulative of. The patterns for the application of the top coat 24 can vary depending upon the desired appearance for the surface component 10, such that the top coat layers 24 that are formed on a surface component 10 desired to have a wood-like appearance will be significantly different from the layers 24 applied to a surface component 10 desired to have a stone, slate or tile-like appearance. More specifically, instead of being applied only between the printing layers 20, the top coat layers 24 can also be applied directly over the printing layers 20, or in any combination thereof. Additionally, this effect can be enhanced by the use of formulations for the top coat layers 24 that have a lower or higher gloss level to create different visual effects.

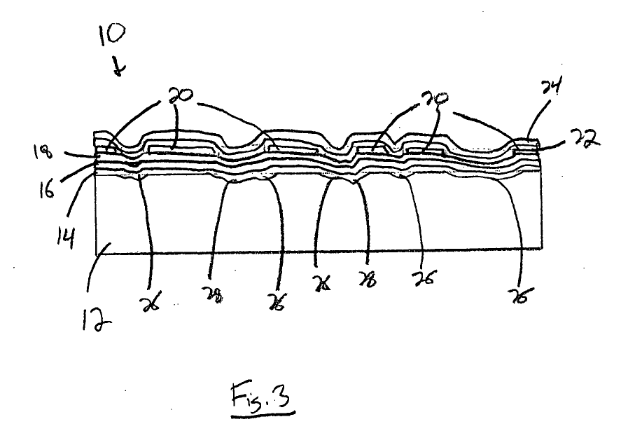

In an alternative embodiment best shown in FIG. 3, the substrate 12 of the surface component 10 can be conditioned prior to, or even completely separate from the use of the patterned top coat layers 24. In this embodiment, the substrate 12 is scraped prior to the initial sanding and preheating steps to form varying grooves 26 and notches 28 in the surface of the substrate 12. The scraping of the substrate 12 can be done by hand, or mechanically, or using a combination thereof, utilizing any suitable scraping tools, such as a CNC machine, a planer and/or sandpaper, among others. Once the substrate 12 has been preconditioned in this manner, the same process as discussed previously can be employed to create a surface component 10 having the desired texture and appearance. However, in the above method, in order to effectively apply the printing layers 20 and finishing layers 22 and 24, the rollers used in applying these layers are altered to have a much lower Shore rating, in order to accommodate for the grooves 26 and notches 28 already present in the substrate 12. Further, when the substrate 12 has been scraped, the top coat layers 24 can be applied in the conventional and printing manner discussed above to enhance the texture and appearance of the surface component 10, or can simply be applied to the substrate 12 in a normal manner, such that the top coat layers 24 do not affect the appearance and texture of the surface component 10 in a significant manner.

Various alternatives are contemplated as being within the scope of the following claims particularly pointing out and distinctly claiming the subject matter regarded as the invention.

I claim:

1. A decorative surface component having a simulated appearance comprising:
a) a substrate having an upper surface;
b) at least one printing layer applied to the upper surface of the substrate for providing a desired appearance to the substrate; and
c) at least one top coat layer applied over the at least one printing layer for providing a desired texture to the upper surface of the substrate.

2. The decorative surface component of claim 1 wherein the at least one top coat layer is applied onto the substrate between lines formed by the at least one printing layer.

3. The decorative surface component of claim 2 wherein the at least one top coat layer is applied as a negative of the at least one printing layer.

4. The decorative surface component of claim 1 further comprising at least one sealing layer applied between the at least one printing layer and the at least one top coat layer.

5. The decorative surface component of claim 4 wherein the at least one sealing layer completely covers the at least one printing layer.

6. The decorative surface component of claim 1 wherein the substrate includes a number of grooves on the upper surface of the substrate beneath the at least one printing layer and the at least one top coat layer.

7. The decorative surface component of claim 6 wherein the at least one printing layer is applied to the substrate between the grooves.

8. The decorative surface component of claim 6 wherein the at least one printing layer is applied to the substrate in alignment with the grooves.

9. A method for forming a decorative component, the method comprising the steps of:
a) applying at least one printing layer to a substrate to form a pattern on the substrate; and
b) applying at least one top coat layer over the at least one layer of printing ink in a manner corresponding to the pattern created by the at least one printing layer to form a texture on the substrate.

10. The method of claim 9 wherein the step of applying the at least one top coat layer comprises applying at least one top coat layer as a negative of the at least one printing layer.

11. The method of claim 9 further comprising the step of applying at least one sealing layer after applying the at least one printing layer.

12. The method of claim 11 wherein the step of applying the at least one sealing layer comprises applying the at least one sealing layer to completely cover the at least one printing layer.

13. A method for forming a decorative board, the method comprising the steps of:
a) deforming an upper surface of a substrate for the board to form a pattern on the board;
b) applying at least one printing layer to the substrate corresponding the pattern formed on the substrate; and
c) applying at least one top coat layer to the substrate over the at least one printing layer to form a texture on the substrate to correspond to the pattern formed on the substrate.

14. The method of claim 13 wherein the step of applying the at least one printing layer comprises applying at least one printing layer to the substrate between the grooves.

15. The method of claim 13 wherein the step of applying the at least one printing layer to the substrate comprises applying the at least one printing layer to the substrate in alignment with the grooves.

16. The method of claim 13 wherein the step of applying the at least one top coat layer comprises applying at least one top coat layer to a substrate between the grooves.

17. The method of claim 13 wherein the step of applying the at least one top coat layer comprises applying the at least one top coat layer to the substrate in alignment with the grooves.

18. The method of claim 13 further comprising the step of applying at least one sealing layer after applying the at least one printing layer.

19. The method of claim 18 wherein the step of applying at least one sealing layer to completely cover the at least one printing layer.

20. The method of claim 13 wherein the step of deforming the upper substrate comprises scraping the upper surface of the substrate.
